(19) United States
(12) Patent Application Publication
(10) Pub. No.: US 2024/0216730 A1
(43) Pub. Date: Jul. 4, 2024

(54) FIRE BARRIER SYSTEM

(71) Applicant: Frank Carretero, Concord, CA (US)

(72) Inventor: Frank Carretero, Concord, CA (US)

(21) Appl. No.: 18/525,441

(22) Filed: Nov. 30, 2023

Related U.S. Application Data
(60) Provisional application No. 63/436,394, filed on Dec. 30, 2022.

(51) Int. Cl. A62C 3/02

(52) U.S. Cl. CPC A62C 3/0257

(57) ABSTRACT

A fire barrier system includes a fire-resisting sheet that has a fire-resisting layer and a support layer. In one version, the fire-resisting layer comprises mineral wool. A support structure is adapted to support the fire-resisting sheet above the ground so that the fire barrier system can be positioned in proximity to a fire to help prevent the spread of the fire across the fire barrier system. A sheet connecting mechanism can also be provided to connect the fire-resisting sheet to a second fire-resisting sheet. The fire barrier system is particularly useful as a fire break in an open area fire.

### PRIORITY

The present application claims the benefit of domestic priority based on U.S. Provisional Patent Application 63/436,394 filed on Dec. 30, 2022, the entirety of which is incorporated herein by reference.

### BACKGROUND

Open area fires, including wildfires, wildland fires, forest fires, brush fires, and the like, can be violently destructive and challenging to manage. To ignite and to spread, an open area fire needs fuel, heat, and oxygen. Fuel typically takes the form of combustible objects such as trees, leaves, grass, and timber. The moisture content, or lack thereof, will determine the combustibility. The initial ignition is triggered by a heat source which can come from any number of events, including natural events, unintentional human activity, and intentional human activity.

Open area fire activity is becoming increasingly common and dangerous in recent years. Climate change is tending to make certain regions hotter and drier than normal, thus increasing the region's fuel available for an open area fire to start and to spread. Climate change is also contributing to drought conditions in many fire-prone areas. A drought not only removes moisture content from fuel, it also can decrease the amount of water that is available to fight an open area fire. Modern forest-management protocols have reduced the number of controlled brush fires in some regions which can add to a buildup of fuel for an open fire. Also, people and developments are increasingly moving into rural and open areas which increases the risk of unintentional fire starts. In addition, the increase in rural population and activity increases the urgency to get open area fires under control to minimize the loss of property and life.

Many techniques are used by firefighters as they attempt to manage an open area fire. While dousing an unwanted open area fire is often desirable, once an open area fire reaches a certain size and scale, complete dousing can be difficult. In these cases, resources are often used to control and direct the open fire so that it does not spread in an unwanted direction, such as towards houses or other developments. Part of this control process often involves the creation of a fire break. A fire break is typically an eight to ten foot wide strip of land cleared by hand and/or bulldozer, the purpose of which is to remove vegetative fuel for the fire and create a barrier strip to prevent the open area fire from progressing over the break. However, fire breaks have several disadvantages. First, they are not always successful, and an open area fire can jump the fire break line, especially when the fire is very large and active. Winds, either from a weather system or generated by the fire itself, can cause a fire to spread by carrying embers in the direction of the wind. When strong enough, winds can carry embers across the fire break line. Another disadvantage of the fire break is the difficulty of its creation. The making of a fire break requires a large team of firefighters and/or bulldozing equipment, both of which can be extremely expensive. Also, open area fires often are in remote locations and/or in rugged terrain that can be difficult to access with the bulldozing equipment.

There is therefore a need for a new fire barrier that can be used to control an open area fire. There is further a need for a fire barrier that is less likely to be jumped by an open area fire. There is further a need for a fire barrier that is portable and/or readily installable in difficult terrain. There is further a need for a fire barrier that is inexpensive, flexible, and/or easily adaptable in its positioning when being used to control an open area fire.

### SUMMARY

The present invention satisfies these needs. In one aspect of the invention, an improved fire barrier is provided to help control an open area fire.

In another aspect of the invention, a fire barrier is provided that controls the spread of an open area fire in an improved manner.

In another aspect of the invention, a portable fire barrier is provided.

In another aspect of the invention, an adjustable fire barrier is provided.

In another aspect of the invention, a flexible fire barrier is provided.

In another aspect of the invention, an upstanding fire barrier system is provided.

In another aspect of the invention, a fire barrier system comprises a vertically orientable sheet of fire-resisting material.

In another aspect of the invention, a fire barrier system comprises a vertically orientable sheet of fire-resisting material that is supportable at least about 18 inches above the ground.

In another aspect of the invention, a fire barrier system comprises a vertically orientable, multi-layered sheet of fire-resisting material.

In another aspect of the invention, a fire barrier system comprises a vertically orientable sheet of fire resisting material, the fire resisting material comprising a mineral wool.

In another aspect of the invention, a fire barrier system comprises a vertically orientable, multi-layered sheet of fire-resisting material, the sheet comprising a layer of mineral wool.

In another aspect of the invention, a fire barrier system comprises a sheet of fire-resisting material and a vertical support structure.

In another aspect of the invention, a fire barrier system comprises a sheet of fire-resisting material and a vertical support structure, the fire-resisting material comprises a mineral wool.

In another aspect of the invention, a fire barrier system comprises a sheet of fire-resisting material and a connecting mechanism to attach the sheet of fire-resisting material to a second sheet of fire-resisting material.

In another aspect of the invention, a fire barrier system comprises a fire-resisting sheet comprising a fire-resisting layer and a support layer, wherein the fire-resisting layer comprises mineral wool, and a support structure adapted to support the fire-resisting sheet above the ground, wherein the fire barrier system can be positioned in proximity to a fire to help prevent the spread of the fire across the fire barrier system.

In another aspect of the invention, a fire barrier system comprises a fire-resisting sheet comprising a fire-resisting layer and a support layer, wherein the fire-resisting layer comprises mineral wool, and a support structure adapted to support the fire-resisting sheet above the ground, wherein the fire barrier system can be positioned in proximity to a fire to help prevent the spread of the fire across the fire barrier system, wherein the fire-resisting layer further comprises a wetting agent.

In another aspect of the invention, a fire barrier system comprises a fire-resisting sheet comprising a fire-resisting layer and a support layer, wherein the fire-resisting layer comprises mineral wool, and a support structure adapted to support the fire-resisting sheet above the ground, wherein the fire barrier system can be positioned in proximity to a fire to help prevent the spread of the fire across the fire barrier system, wherein the support layer comprises a para-aramid or a meta-aramid.

In another aspect of the invention, a fire barrier system comprises a fire-resisting sheet comprising a fire-resisting layer and a support layer, wherein the fire-resisting layer comprises mineral wool, and a support structure adapted to support the fire-resisting sheet above the ground, wherein the fire barrier system can be positioned in proximity to a fire to help prevent the spread of the fire across the fire barrier system, wherein the fire resisting sheet comprises a sheet connecting mechanism adapted to connect the fire-resisting sheet to a second fire-resisting sheet, the sheet connecting mechanism comprising an extending portion of the fire-resisting sheet that extends beyond the fire-resisting layer, the extending portion comprising a fastening member adapted to connect to the second fire-resisting sheet in a manner that maintains fire barrier properties of the system.

In another aspect of the invention, a fire barrier system comprises a first fire-resisting sheet comprising a fire-resisting material, a second fire-resisting sheet comprising a fire-resisting material, and a sheet connection mechanism adapted to connect the first fire-resisting sheet to the second fire-resisting sheet to extend the length or height of the fire barrier system.

In another aspect of the invention, a fire barrier system comprises a first fire-resisting sheet comprising a fire-resisting material, a second fire-resisting sheet comprising a fire-resisting material, and a sheet connection mechanism adapted to connect the first fire-resisting sheet to the second fire-resisting sheet to extend the length or height of the fire barrier system, wherein the sheet connection mechanism comprises an extending portion of the first sheet that extends beyond the fire-resisting material of the first sheet, wherein the extending portion contains a first fastening member, wherein the second fire-resisting sheet comprises a second fastening member, and wherein the first fastening member can engage a second fastening member to connect the first fire-resisting sheet to the second fire-resisting sheet in a manner that maintains fire barrier properties of the system.

In another aspect of the invention, a fire barrier system comprises a first fire-resisting sheet comprising a fire-resisting material, a second fire-resisting sheet comprising a fire-resisting material, and a sheet connection mechanism adapted to connect the first fire-resisting sheet to the second fire-resisting sheet to extend the length or height of the fire barrier system, wherein the sheet connecting mechanism comprises a horizontal connecting mechanism and a vertical connecting mechanism.

In another aspect of the invention, a fire barrier system comprises a first fire-resisting sheet comprising a fire-resisting material, a second fire-resisting sheet comprising a fire-resisting material, and a sheet connection mechanism adapted to connect the first fire-resisting sheet to the second fire-resisting sheet to extend the length or height of the fire barrier system, wherein the fire-resisting material comprises mineral wool.

In another aspect of the invention, a method of creating a fire barrier comprises using a fire barrier system as disclosed herein.

In another aspect of the invention, a method of creating a fire barrier between a fire and an area to be protected from the fire comprises supporting a fire-resisting sheet above the ground at a location between the fire and the area to be protected from the fire, the fire resisting sheet comprising a fire-resisting material.

In another aspect of the invention, a method of creating a fire barrier between a fire and an area to be protected from the fire comprises supporting a fire-resisting sheet above the ground at a location between the fire and the area to be protected from the fire, the fire resisting sheet comprising a fire-resisting material, wherein the fire-resisting sheet is supported at a location in proximity to a fire break line.

In another aspect of the invention, a method of creating a fire barrier between a fire and an area to be protected from the fire comprises supporting a fire-resisting sheet above the ground at a location between the fire and the area to be protected from the fire, the fire resisting sheet comprising a fire-resisting material, further comprising connecting the fire-resisting sheet to another fire-resisting sheet to extend the length or height of the fire barrier.

### DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1 is a schematic perspective front view of a fire barrier system according to the invention positioned in the area of an open area fire;

FIG. 2A is a schematic perspective front view of another version of a fire barrier system of the invention;

FIG. 2B is a schematic perspective front view of another version of a fire barrier system of the invention;

FIG. 3A is a schematic perspective front view of a fire-resisting sheet of the fire barrier system of the invention;

FIG. 3B is a schematic sectional view of the fire-resisting sheet of FIG. 3A;

FIG. 4A is a schematic perspective front view of another version of a fire-resisting sheet of the fire barrier system of the invention;

FIG. 4B is a schematic sectional view of the fire-resistance sheet of FIG. 4A;

FIG. 5A is a schematic perspective front view of a vertical support structure of the fire barrier system of the invention;

FIG. 5B is a schematic side view of the vertical support member of FIG. 5A;

FIG. 5C is a schematic side view of another version of a vertical support structure of the fire barrier system of the invention;

FIG. 6A is a schematic perspective front view of a version of the fire barrier system of the invention with a fire-resisting sheet installed on a vertical support structure;

FIG. 6B is a schematic sectional view of the fire barrier system of FIG. 6A;

FIG. 7A is a schematic perspective front view of a version of a fire-resisting sheet of the fire barrier system having a connecting mechanism;

FIG. 7B is a schematic perspective rear view of the fire-resisting sheet of FIG. 7A;

FIG. 8 is a partially-exploded schematic perspective front view of four fire-resisting sheets of FIG. 7A connected or connectable to one another;

FIG. 9 is a schematic perspective front view of two fire-resisting sheets of FIG. 7A connected to one another and installed on a support structure of the fire barrier system;

FIG. 10 is a schematic perspective front view of the two fire-resisting sheets of FIG. 9 connected to one another and installed on another version of a support structure of the fire barrier system;

FIG. 11A is a schematic perspective view of a fire barrier system of the invention configured to enclose a fire;

FIG. 11B is a schematic perspective view of a fire barrier system of the invention configured to enclose a property to be protected from an open area fire;

FIG. 12 is a schematic perspective view of a version of a fire barrier system in a rolled-up, portable configuration;

FIG. 13A is a schematic perspective front view of a version of the fire barrier system of the invention with a version of a fire-resisting sheet installed on a version of a support structure;

FIG. 13B is a schematic perspective rear view of the version of the fire barrier system of FIG. 13A;

FIG. 14A is a schematic perspective front view of a version of the fire barrier system of the invention with a series of a version of fire-resisting sheets installed on a version of a support structure; and

FIG. 14B is a schematic perspective rear view of the version of the fire barrier system of FIG. 14A.

### DESCRIPTION

The present invention relates to a fire barrier system and its components. In particular, the invention relates to a fire barrier system having one or more fire-resisting sheets and a support structure. Although the fire barrier system and its components are illustrated and described in the context of being useful for controlling open area fires, the present invention can be useful in other instances. Accordingly, the present invention is not intended to be limited to the examples and embodiments described herein.

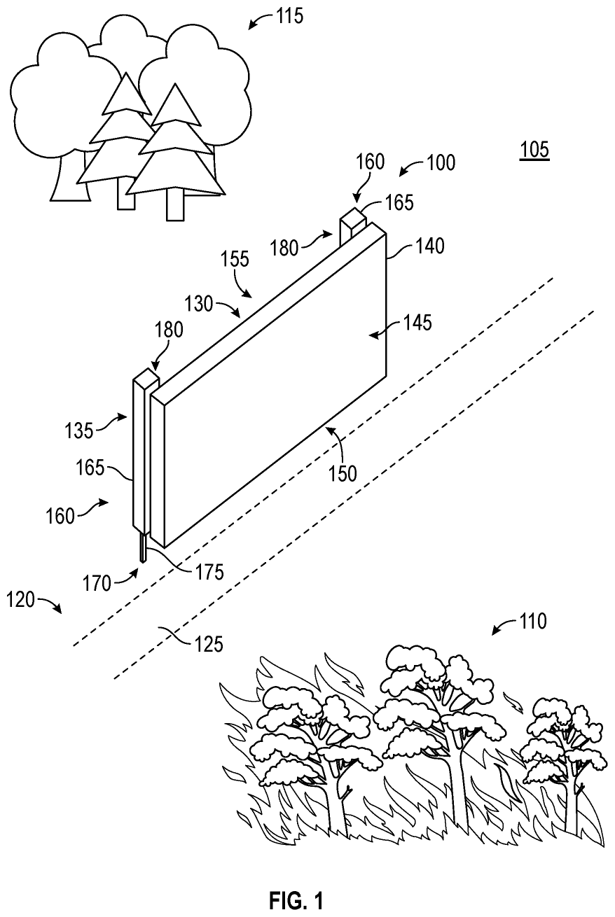

FIG. 1 shows a fire barrier system 100 positioned in an open area 105 between an open area fire 110 and a protected region 115 of the open area 105. The fire barrier system 100 is positionable in, on, or above the ground 120 of the open area 105 and is designed to help prevent the open area fire 110 from spreading into the protected region 115 of the open area 105. A fire break line 125 may optionally be provided at or near the position of the fire barrier system 100. The fire break line 125 can be, for example, a line of upturned soil created by firefighters and/or bulldozing equipment that is typically between eight and ten feet wide. The fire break line 125, of course, need not be a straight line but can have curves and can be shaped to the contour of the land. The fire barrier system 100 can be positioned on, in front of, or behind the fire break line 125. Alternatively, the fire barrier system 100 can be used in the absence of a fire break line. This alternative is particularly useful when a fire barrier is needed in terrain that is difficult to access with bulldozing equipment or when a fire barrier is needed to be employed rapidly and less expensively.

An open area fire 110 can be any fire that is in a region of an open area 105 and that is spreadable to another region of the open area 105. The open area 105 can be a forest, meadow, grassland, development, developing region, city, or any other type of area where fire can spread. Typically, the fastest moving open area fires 110 are in hot, dry regions with low humidity. These types of open area fires 110 can spread rapidly. Examples of open area fires 110 include forest fires, wildfires, wildland fires, and brush fires. However, open area fires 110 can also exist and/or start in areas of rural, suburban, industrial, and even urban development. The open area fire 110 can start naturally, such as by lightning strike, by accident, such as by an unwanted spark, an unsuccessfully extinguished cigarette, an untended campfire, or a house or car fire that spreads into brush or an adjacent property, or intentionally, such as by being a prescribed or controlled burn or by being set by arson. No matter the cause of the start of the open area fire 110, once it has started and has built in strength, it can be difficult to douse. In such case, it is often desirable to use the fire barrier system 100 of the present invention alone or in conjunction with a fire break line 125 to help control the spread and/or the direction of spread of the open area fire 110. The fire barrier system 100 can help to stop the progress of an existing open area fire 110 and/or can help to redirect the fire away from a protected region 115. Alternatively, the fire barrier system 100 can be installed at a location before an open area fire 110 has been ignited. For example, a fire barrier system 100 can be installed around the perimeter of the location of a controlled burn that is going to be prescribed or can be positioned between the location of where a controlled burn is going to be prescribed and a protected area 115, such as a structure or a residential neighborhood or the like. In one use, one or more fire barrier systems 100 can be paid flat across at least a portion of a fire break line 125 or can be used to create a fire break. Alternatively still, the fire barrier system 100 can be more permanently installed in a strategic location in an area particularly prone to open area fires 110 in anticipation of a possible open area fire 110 in the area.

In the version shown in FIG. 1, the fire barrier system 100 is made up of a fire-resisting sheet 130 and a support structure 135. The fire-resisting sheet 130 has a body 140 that includes one or more fire-resisting materials 145. By fire-resisting material it is meant a material that is either naturally resistant to ignition by fire or flame or a material that has been treated by a fire or flame retardant to make the material more resistant to fire or flame than when untreated. In one version, the fire-resisting material 145 can comprise one or more fire or flame resistant materials, meaning that the material can pass the ASTM vertical flame test. To pass the ASTM vertical flame test the material is suspended over a vertical flame for 12 seconds and is then removed from the flame, and the material must self-extinguish in two seconds. A fire-resisting material 145 can also be any material that is not readily ignitable by open fire embers in an open fire environment. The fire-resisting sheet 130 has a front side 150 that is adapted to face in the direction of an approaching or anticipated open area fire 110 and a rear side 155 that is adapted to face in the direction opposite to the fire or in the direction of a protected region 115 of the open area 105. The front side 150 is at least as fire-resisting as the rear side 155, and in one version of the fire barrier system 100, the front side 150 is made of a material that is more fire-resisting than the rear side 155. The fire-resisting sheet 130 when properly positioned thus can help to block or resist the advance of an open area fire 110. For example, the fire-resisting sheet 130 can slow the progress of an open area fire 110 by blocking the fire from reaching fuel on the other side of the fire barrier system 100 or between the fire barrier system 100 and the region that is to be protected region 115. In addition, the fire-resisting sheet 130 can prevent or reduce the passage of embers therethrough and therebeyond to reduce the chances of the open area fire 110 to spread by spotting in the direction of the protected region 115. Accordingly, an advancing open area fire 110 is less likely to spread beyond the fire barrier system 100 than it would be in the absence of the fire barrier system 100.

As also shown in FIG. 1, the support structure 135 is adapted to support the fire-resisting sheet 130 in an at least partially elevated position off the ground 120. For example, as shown, the support structure 135 can support the fire-resisting sheet 130 in an upstanding position, where the fire-resisting sheet is maintained in an upright and/or a non-horizontal position and/or includes a portion that is elevated at least 18 inches off the ground. In the particular version shown in FIG. 1, the fire-resisting sheet 130 is supported by the support structure 135 in a manner so that at least a portion of the fire-resisting sheet is at least 18 inches above the ground and/or in a substantially vertical position. By substantially vertical it is meant that when positioned on the support structure 135, the fire-resisting sheet 130 has a greater portion extending substantially along or near a vertical plane than a portion that is lying along a horizontal plane, with both the vertical and the horizontal being relative to the ground where the fire barrier system 100 is positioned. In the version of FIG. 1, the support structure 135 is made up of one or more vertical support members 160, each having an above-ground or connecting portion 165 and an anchoring portion 170. In the version of FIG. 1, the anchoring portion 170 is made up of a below-ground stake 175. The above-ground portion 165 includes a fastening system 180 that is connectable to the fire-resisting sheet 130 to allow the fire-resisting sheet 130 to be supported in its upright position with its front side 150 facing an oncoming or potentially oncoming open area fire 110. Alternatively, the support structure 135 can be an integral and/or internal structural feature on or within the fire-resisting sheet 130.

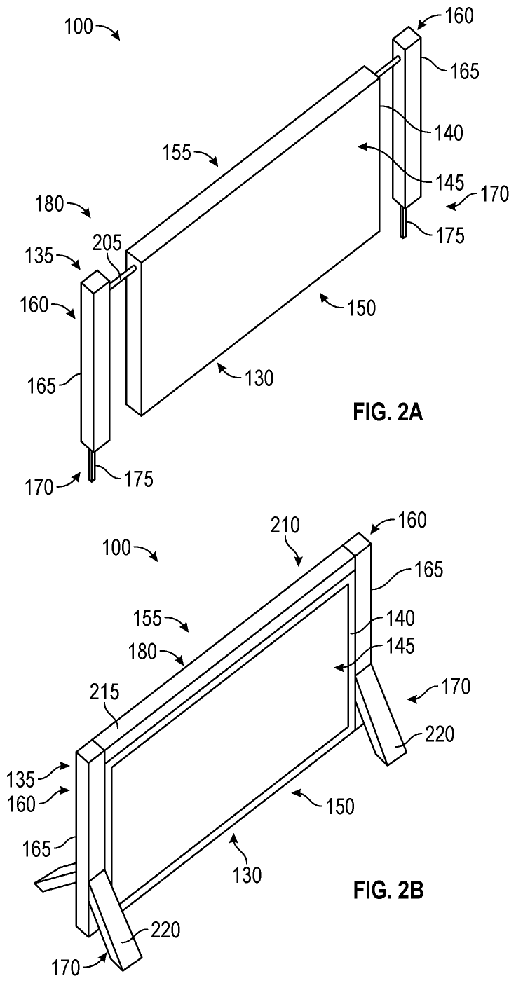

The fastening system 180 for connecting the fire-resisting sheet 130 to the one or more vertical support members 160 can include any suitable system of attachment. In one version, the fire-resisting sheet 130 can be permanently attached to vertical support member 160, such as by glue or other adhesive. Alternatively, the fire-resisting sheet 130 can be releasably attached to a vertical support member 160, such as by pins or bolts, as will be described hereinbelow. FIGS. 2A and 2B show additional and/or alternative fastening systems 180. In FIG. 2A, the fastening system 180 can include a cross member 205, such as a wire, string, or bar, that extends from one vertical support member 160 to a second vertical support member 160. The fire-resisting sheet 130 can be hung, hooked, and/or draped from the cross member 205 so that it is supported in an upright position. In the version of FIG. 2B, the fire-resisting sheet 130 is supported by a rigid frame 210 made up of two vertical support members 160 and one or two horizontal support members 215. As also shown in FIG. 2B, the anchoring portion can be an outwardly extending stand 220 rather than or in addition to the below ground stake 175.

In one version, the fire-resisting sheet 130 comprises, consists essentially of, or consists of a mineral wool. By mineral wool it is meant any fibrous material formed by spinning or drawing molten minerals. Mineral wool is also known as mineral fiber, mineral cotton, mineral fibre, man-made mineral fiber, and man-made vitreous fiber. Examples of mineral wool are stone wool or rockwool, slag wool, and glass wool. In particular, stone wool is made using basalt volcanic rocks that are melted in a high temperature furnace, blown with air to create fibers that form granules and/or is made with a combination of one or more of basalt, magma, and molten volcanic rocks. The mineral wool is fire-resistant and noncombustible. The mineral wool present in the fire-resisting sheet 130 in this version can be a single type of mineral wool, such as stone wool, or can be a mixture of different types of mineral wool.

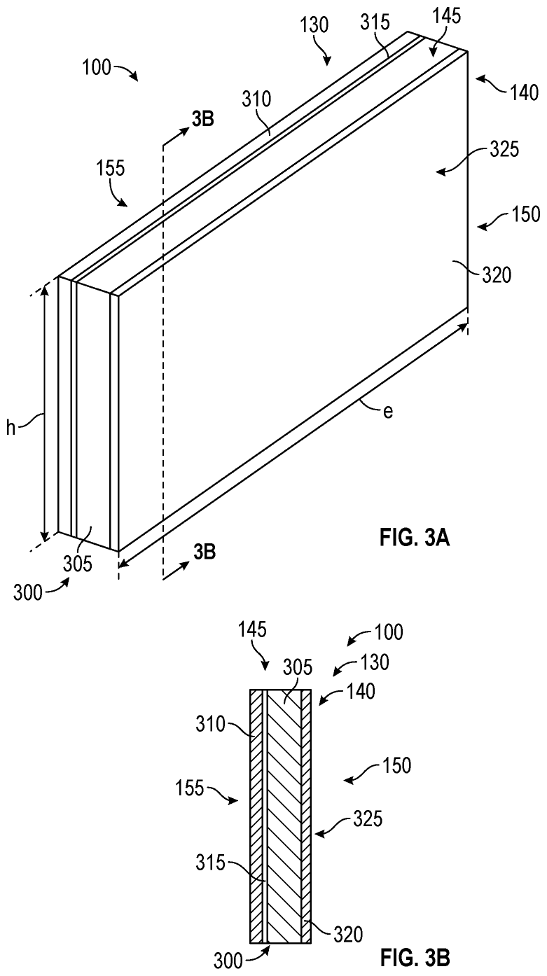

In one version, as shown in FIGS. 3A and 3B, the fire-resisting sheet 130 can be made up of one or more layers 300 of material that together form a sheet of material that can be used as the fire-resisting sheet 130 of the fire barrier system 100. At least one fire-resisting layer 305 extends at least a majority of the length, l, and height, h, of the fire-resisting sheet 130 and preferably for substantially the entire length and height of the fire-resisting sheet 130. In one version, the fire-resisting layer 305 can include of be made up entirely of a mineral wool. The use of a mineral wool in the fire-resisting layer 305 is an advantageous fire-resisting material for several reasons. For example, in addition to being non-combustible, the mineral wool can absorb and retain water. Thus, in the presence of an open area fire 110, the mineral wool containing fire-resisting sheet 130 can be wetted to even further increase its fire barrier properties. In addition, the mineral wool containing layer is sufficiently strong to withstand fire and wind without being ripped apart. In addition to being noncombustible, mineral wool is particularly advantageous for the material in the fire-resisting layer 305 because it does not require any fire-retardant chemical treatment and because it is highly resistant to deterioration and mold. In one version, the fire-resisting layer 305 comprises a material, such as a mineral wool, that passes the ASTM-C411 standard test. In one version, the fire-resisting layer 305 comprises a material, such as a mineral wool, that generates no flame spread and no smoke detection at temperatures ranging from −49 degrees C. to 650 degrees C.

In one version, the fire-resisting layer 305 can be at least 50 percent mineral wool, and in one particular version can be from about 90 to about 100 percent mineral wool. The fire-resisting layer 305 and/or the mineral wool within the fire-resisting layer 305 can be from about 1 inch to about 7 inches thick, and in one particular version is about 3 inches thick (ASTM E-84). Optionally, the fire-resisting layer 305 can comprise mineral wool and a wetting agent. Wetting agents typically are a 1-3% formaldehyde resin either oil based or water based. Water based resins can retain up to five times their weight in water. The wetting agent allows for added water absorption or retention capabilities. The above-ground water retention can add protection against the progress of fire over the fire barrier system 100.

In one version, such as the version of FIGS. 3A and 3B, one or more additional layers may be provided. For example, the fire-resisting sheet 130 can include a support layer 310 that provides a structural support to the fire-resisting sheet 130. The support layer 310 can be made of any material that adds structural support to the fire-resisting layer 305 and that makes the fire-resisting sheet 130 more resistant to being torn or damaged by wind or use than if the fire-resisting sheet 130 lacked the structural layer. Optionally, the support layer 310 can also be made or can include fire-resisting material. For example, in one version, the support layer 310 comprises an aramid or a para-aramid, such as poly-paraphenylene terephthalamide (K29), commercially known as Kevlar®, and/or a meta-aramid, such as poly(meta-phenyleneisophthalamide), commercially known as Nomex®. In one particular version, the support layer 310 comprises a blend of Kevlar and Nomex, which provides added structural strength and rip-protection from the Kevlar and added thermal and flame resistance from the Nomex. Additionally or alternatively, the support layer 310 can comprise duvetyne, also known as duvetyn, Molton, and/or Rokel, which is a twill fabric known for its fire-resisting properties, a fiberglass fire-resisting blanket, a high-temperature carbon fiber, such as Newtex, and/or a fabric made with silver which will melt rather than combust in an active fire.

In the version of FIGS. 3A and 3B, the support layer 310 is provided on the rear side 155 of the fire-resisting sheet 130 relative to the fire-resisting layer 305. This provides the greatest amount of fire-resistance on the side of the approaching open fire 110. Alternatively, the positioning of the layers can be reversed, particularly when the support layer 310 is made of a fire-resisting material itself, thus providing a first layer of protection that is supplemented by the fire-resisting layer 305. In another version, a support layer 310 can be provided on both the rear side and the front side of the fire-resisting layer 305. Optionally, as shown in FIGS. 3A and 3B, an intermediate layer 315 can be provided between the support layer 310 and the fire-resisting layer 130. The intermediate layer 315 can, for example, help attach or bond the fire-resisting layer 305 to the support layer 310. In one particular version, the intermediate layer 315 comprises a fabric, such as polyethylene terephthalate or Dacron. The intermediate layer 315 can be positioned between the support layer 310 and the fire-resisting layer 305, as shown. In the version with a support layer 310 or both sides of the fire-resisting layer 305, a pair of intermediate layers 310 can be provide with one on opposite sides of the fire-resisting layer 305.

In addition, optionally, a fronting layer 320 can be provided that rests against the fire-resisting layer 305 or other layer to help secure the fire-resisting layer 305 to the fire-resisting sheet 130 and/or the helps prevent portions of the fire-resisting layer 305 from separating from the fire-resisting sheet 130. In one version, the fronting layer 320 comprises a wire or netting type structure, preferably made of a metal or the like so as to minimize combustibility. The fronting layer 320 can be used to rest and/or press against the fire-resisting layer 305. This type of fronting layer 320 provides a lightweight and flexible fronting material. The openings in the wire or netting allow the front surface 325 of the fire-resisting sheet 130 to be at least partially, and preferably mostly, made up of the fire-resisting layer 305. In one version, the fronting layer 320 comprises a galvanized wire or netting, such as 20 gauge galvanized netting commonly known as chicken wire, that Alternatively, galvanized hardware cloth netting, such as one-quarter inch netting, and/or the like. In another version, a layer similar to or identical to the fronting layer 320 can be provided at another position in the fire-resisting sheet 130. Optionally, the fronting layer 320 can include another layer of fire-resisting material, such as Kevlar and/or Nomex that is on the front side of the wire or metal netting.

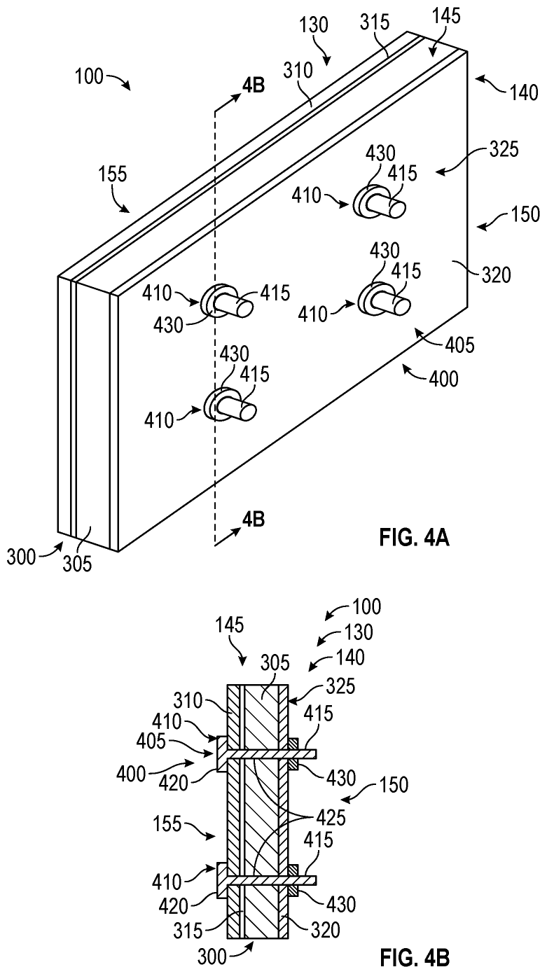

The layers 300 of the fire-resisting sheet 130 when the fire-resisting sheet contains multiple layers can be assembled and/or held together in any suitable manner. For example, the layers 300 can be held together by bonding and/or adhesive. Alternatively, the layers 300 can be fastened together individually or collectively. FIGS. 4A and 4B show a version of a fire-resisting sheet 130 similar to the one shown in FIGS. 3A and 3B with a fastening system 400 provided to hold at least two of the layers 300 together. In the particular version shown, the fastening system 400 is a clamping system 405 that clamps all of the layers 300 together. In addition to being clamped together by the clamping system 405, pairs of adjacent layers 300 can also be connected to one another, such as by bonding or adhesive. In the particular version shown, the clamping system 405 can include one or more clamps 410 each made up of a threaded shaft 415 having an integrated head 420 at one end. The threaded shaft 415 can extend through an opening 425 in each of the layers 300. A metal nut 430 or the like is receivable on the threaded shaft 415 so that the head 420 and the nut 430 can clamp the layers 300 therebetween. By clamping it meant that the fastener prevents separation of the layers beyond a predetermined amount by blocking the movement of the layers away from one another at some point. The clamping may but need not necessarily squeeze or compress the layers towards one another. Whether or not there is any such squeezing or compression would depend on the thickness of the materials and the distance between the head 420 and the nut 430. A small amount of sliding of the layers on the threaded shaft 415 would be possible with the clamping system 405 or the clamping system can compress the layers so there is no movement. The threaded shaft 415 and nut 430 can be replaced by any other similar clamping system 405 such as an anchor or a non-threaded clevin or cotter pin system. When using a wire netting as the fronting layer 320, the nut 430 should be larger than the openings of the netting or a washer can be provided as discussed below.

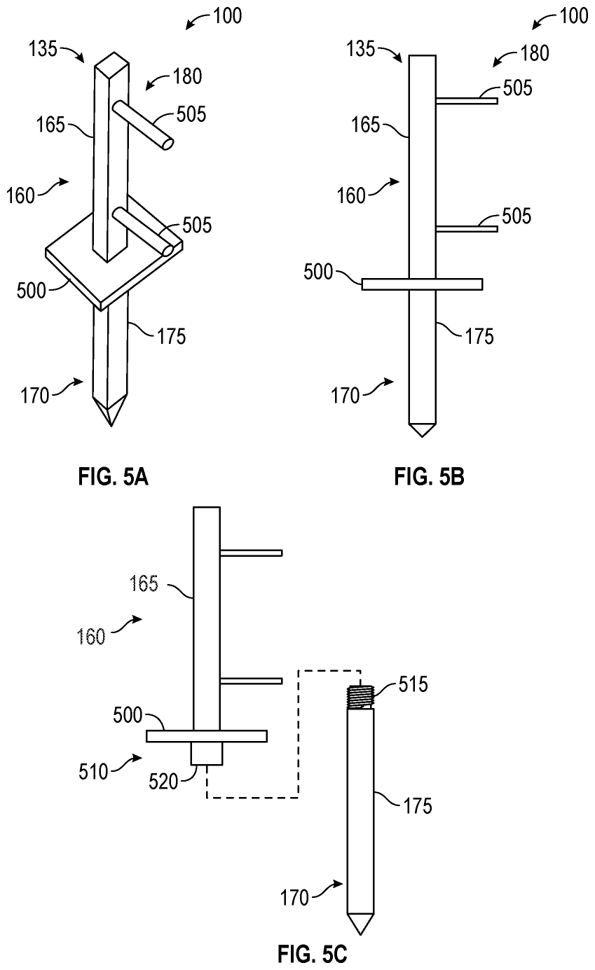

FIGS. 5A and 5B show an example of a support structure 135 that can be used with the fire barrier system 100 to support the fire-resisting sheet 130 in a desired location. In this version, the support structure 135 is a vertical support member 160 having an above ground portion 165 and a below ground anchoring portion 170 separated by a ground plate 500. The ground plate 500 is adapted to rest on top of the ground 120 when the below ground stake 175 is inserted into the ground 120. The ground plate 500 serves both to stabilize the support structure 130 and to assure the support structure is at a proper and desired height. Extending from a side of the vertical support member 160 is an attachment system and fastening system 180 comprising one or more shafts 505 for attaching a fire-resisting sheet 130 to the vertical support member 160. An appropriately sized opening 425 in the fire-resisting sheet 130 can be slid over one of the shafts 505, and the shaft 505 alone or with a second or more shaft 505 and opening 425 can support the weight of the fire-resisting sheet 130. In one version, the shaft 505 can be threaded, or the like, so that a nut 430 can be attached to the shaft to prevent the fire-resisting sheet 130 from falling off the shaft 505. In addition, the shaft 505 and nut 430, or the like, can be used as a combination attachment and clamp 600, as shown and discussed below, that serves to attached the fire-resisting sheet 130 to the vertical support member 160 and also serves as a clamping system 405 or as part of a clamping system 405 for securing the layers 300 of the fire-resisting sheet 130 together. The shaft 505 which may be threaded and adapted to receive a nut 430 or not threaded can be integrally or removeably connected to the vertical support member 160. FIG. 5C shows another version of a vertical support member 160. In this version, the vertical support member 160 includes a connection portion 510 that allows the below-ground stake 175 to be removable from the above-ground portion 165. In the particular version shown, the connection portion 510 comprises a threaded male portion 515 on the below-ground stake 175 that can be screwed into a female threaded portion 520 connected to the above-ground portion 165. The ground plate 500 can be provided on either of the portions or can also be separatable and separately storable.

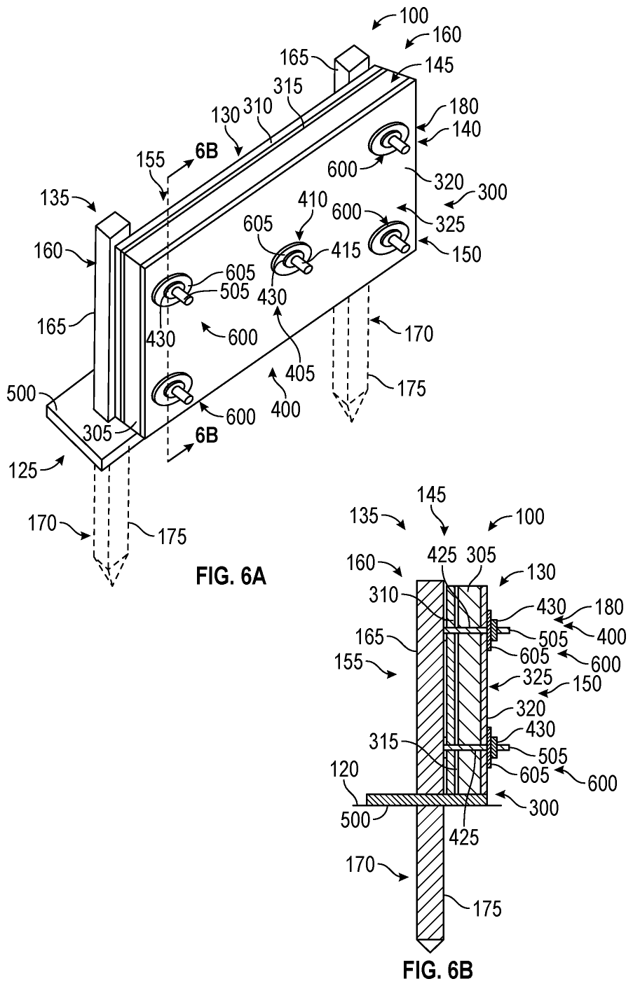

FIGS. 6A and 6B show a fire barrier system 100 with a fire-resisting sheet 130 being attached to a support structure 135 having a pair of vertical support members 160. In the version shown, each vertical support 160 has a fastening system 180 made up of a pair of shafts 505 that each serve as a combination attachment and clamp 600. Alternatively, a single shaft 505 can be provided or more than two shafts 505 can be provided on each vertical support member 160. As can also be seen, one or more additional clamps 410 can optionally also be provided between the vertical support members 160. Also shown are optional washers 605 for when the nut 430 is not sufficiently large to secure the fronting layer 320 of the fire-resisting sheet 130 and/or to provide a more secure clamp. Alternatively for the combination attachment and clamp 600, a bolt or the like can be screwed directly through the fire-resisting sheet 130 and into a vertical support member 160.

The fire-resisting sheet 130 of the fire barrier system 100 can have any suitable shape and size for its intended purpose and position of use. In the version shown in FIG. 3A, the fire-resisting sheet 130 is shown to be rectangular having a length, l, and a height, h. In one version, the length can range from about 2 feet to about 16 feet, though smaller or longer versions are possible, and the height can range from about 6 inches to about 12 feet, or from about 18 inches to about 6 feet, and more preferably from about 2 feet to about 4 feet. In any of these cases, the overall length or height of the fire barrier system 100 can be altered by using a plurality of fire-resisting sheets 130, as discussed below. The rectangular shape of the fire-resisting sheet 130 can be altered to any other shape, such as a round or polygonal shape, as desired. The support structure 135 can be sized and shaped to correspond to the size and shape of the fire-resisting sheet or sheet 130. In one particular version, the support structure 135 comprises metal vertical support members that are from about 40 to about 70 inches tall.

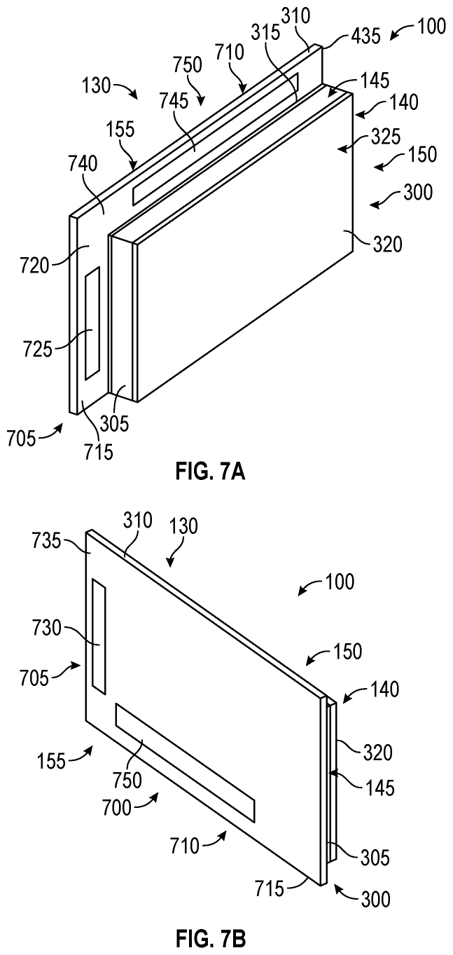

Another version of a fire-resisting sheet 130 of a fire barrier system 100 is shown in FIGS. 7A and 7B. In this version, the fire resisting sheet 130 has a sheet connecting mechanism 700 that allows one fire-resisting sheet 130 to be connected to another fire-resisting sheet 130. The sheet connecting mechanism 700 is designed to allow multiple fire-resisting sheets 130 to be connected to one another to extend the length and/or height of the fire barrier system 100 in a manner where the fire barrier properties are maintained at the connection. By maintained it is meant that there is no significant gap of fire-resisting material 145 created that is large enough for fire to pass easily through.

The connecting mechanism 700 can comprise a horizontal sheet connecting mechanism 705 and/or a vertical sheet connecting mechanism 710. The horizontal sheet connecting mechanism 705 allows two or more fire-resisting sheets 130 to be connected in the generally horizontal direction, thus allowing the fire barrier system 100 to be lengthened in the horizontal direction. The term horizontal here is merely intended to define the direction of connection and is not intended to require that a portion lies in a horizontal plane. The vertical sheet connecting mechanism 710 allows two or more fire-resisting sheets 130 to be connected to one another in the in the generally vertical direction, thus allowing the fire barrier system 100 to be heightened relative to the ground. The term vertical is likewise used merely to show direction of connection. In the horizontal sheet connecting mechanism 705 of the version of FIGS. 7A and 7B, the support layer 310 has a horizontally extending portion 715 that extends horizontally beyond one or more other layers of the fire-resisting sheet 130. On a front-facing side 720 of the horizontally extending portion 715 is positioned a first horizontal fastening member 725. The first horizontal fastening member 725 is engageable with a second horizontal fastening member 730 on a second fire-resisting sheet 130 with the second horizontal fastening member 730 being positioned on the rear side 155 of the fire-resisting sheet 130 on the end opposite to the horizontal extending portion 715. The first horizontal fastening member 725 and the second horizontal fastening member 730 can be any type of cooperating fasteners. For example, in one version, the first horizontal fastening member 725 and the second horizontal fastening member 730 are hook and loop, also known as Velcro, fasteners. Preferably the Velcro has a fire-resistant coating applied thereto. In addition, by nature of the positioning of the first horizontal fastening member 725 and the second horizontal fastening member 730, the material of the supporting layer 310 provides additional protection. Optionally, flaps or additional pieces of material can be provided to protect fastening members that are not attached to another fastening member.

Additionally or alternatively, the connecting mechanism 700 can include a vertical sheet connecting mechanism 710 as shown in FIGS. 7A and 7B. For example, the vertical sheet connecting mechanism 710 can include a vertically extending portion 735 of the support layer 310 that extends vertically beyond one or more other layers of the fire-resisting sheet 130. On a front-facing side 740 of the vertically extending portion 735 is positioned a first vertical fastening member 745. The first vertical fastening member 745 is engageable with a second vertical fastening member 750 on a second fire-resisting sheet 130 with the second vertical fastening member 750 being positioned on the rear side 155 of the fire-resisting sheet 130 on the top or bottom end opposite to the vertical extending portion 735. The first vertical fastening member 745 and the second vertical fastening member 750, like the first horizontal fastening member 725 and the second horizontal fastening member 730, can be any suitable type of fastening mechanism, and in one particular version is hook and loop. The terms horizontal and vertical, of course, are used solely for the purpose of description of the systems when being used to connect upright or upstanding sheets, and the terms are not intended to limit the use to that orientation. For example, when the sheets are lying flat on the ground, the horizontal and vertical directions as used above would both be in orthogonal horizontally extending directions.

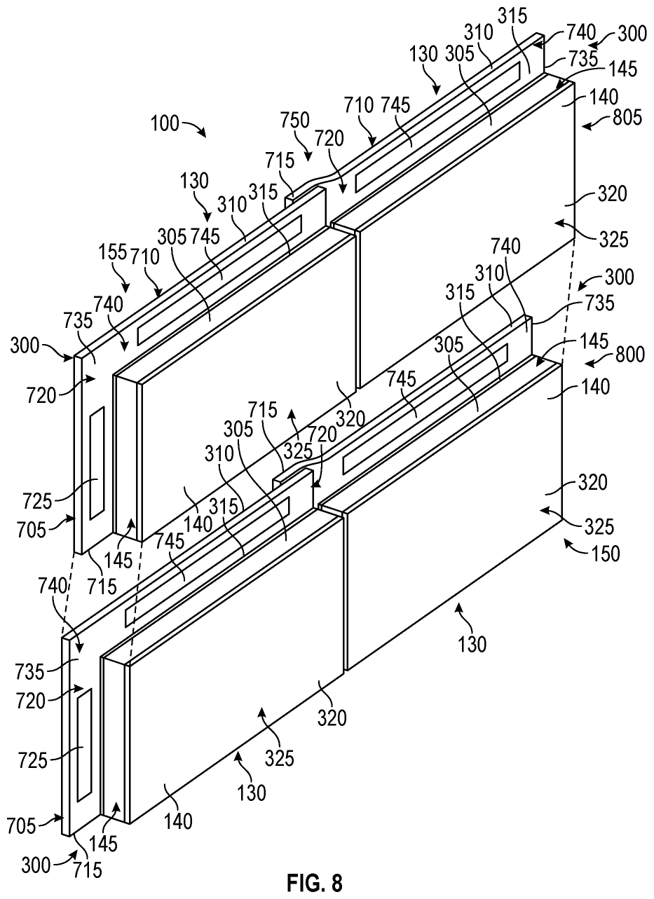

FIG. 8 shows a fire barrier system 100 with a first pair 800 of fire-resisting sheets 130 connected to one another by a horizontal sheet connecting system 705 and with a second pair 805 of fire-resisting sheets 130 connected to one another by a horizontal sheet connecting system 705. The first pair 800 and the second pair 805 of fire-resisting sheets 130 are then connectable to each other by the vertical sheet connecting system 710.

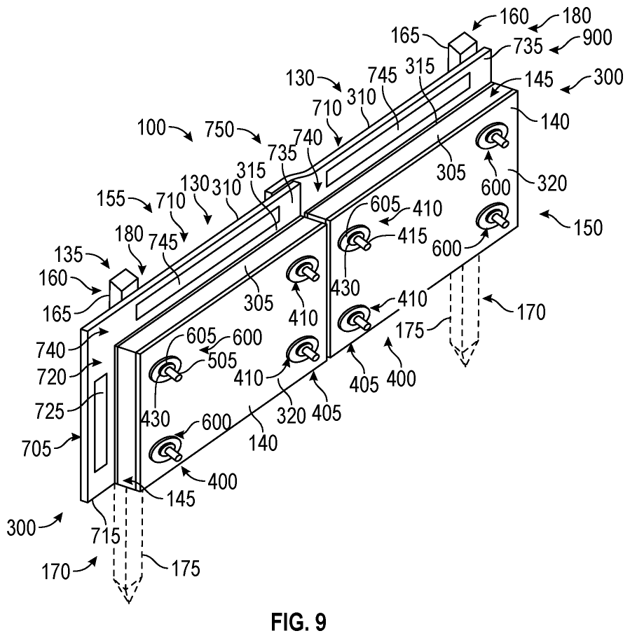

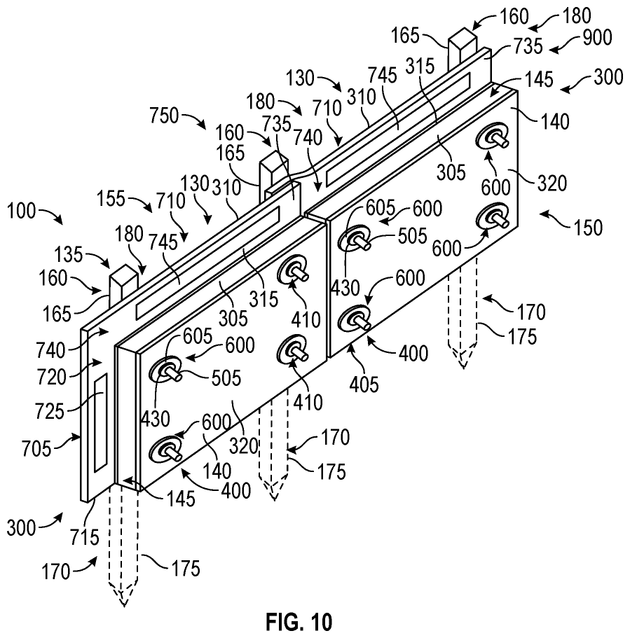

FIGS. 9 and 10 show a fire barrier system 100 with a supported pair 900 of fire-resisting sheets 130 connected to one another by a horizontal sheet connecting system 705. In the version of FIG. 9, the connected supported pair 900 of fire-resisting sheets 130 is supported on a pair of vertical support members 160. In the version of FIG. 10, the connected supported pair 900 of fire-resisting sheets 130 is supported on a pair of vertical support members 160 with an additional intermediate vertical support member 160 provided at the connection of the pair of fire-resisting sheets 130.

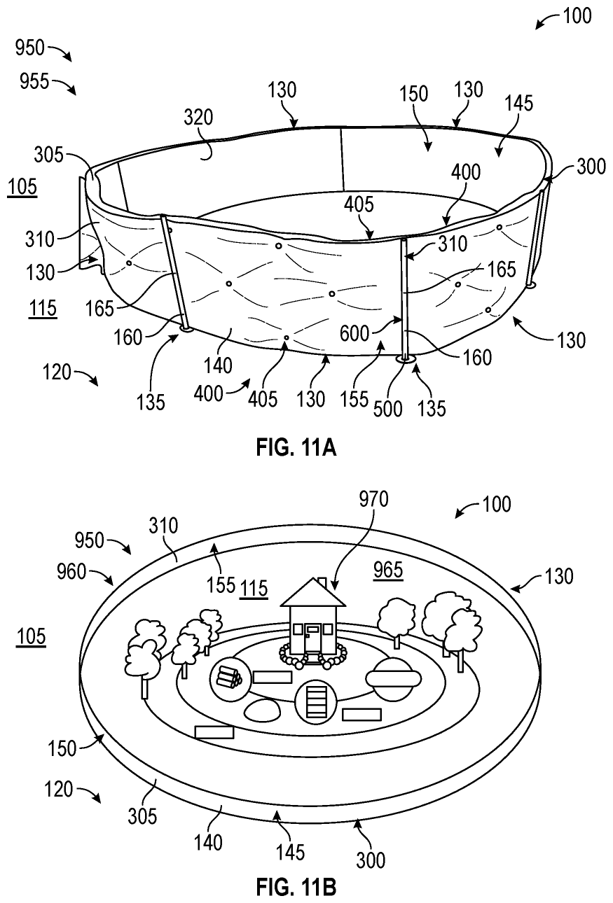

In addition to being used as an alternative to or in conjunction with a fire break line 125 to create a fire break to help stop and/or redirect the progress of an open area fire 110, the fire barrier system 100 of the invention can also be used in other manners. For example, as shown in FIGS. 11A and 11B, the fire barrier system 100 can be used as an enclosure barrier 950. By enclosure barrier it is meant that the fire barrier system 100 is used to enclose or encircle at least a majority of an object, such as by enclosing at least 180 degrees around the object. In one version, the enclosure barrier 950 can be used to enclose at least 270 degrees around an object, and in one version, the enclosure barrier 950 can be used to substantially entirely enclose or enclose about 360 degrees around an object. In the version of FIG. 11A, the enclosure barrier 950 is an outward protection system 955 with the object to be enclosed by the enclosure barrier 950 being the fire itself. With the outward barrier system 955, the fire-resisting sheet or sheets 130 are positioned as an enclosure with the front side 150 facing inwardly towards a fire within the enclosure barrier 950. The outward protection system 955 is useful whenever a smaller fire is desired to be contained. For example, an outward protection system 955 can be set up around a controlled burn to help prevent the controlled burn from getting out of control. An even smaller outward barrier system 955 can be set up around a burn pile to help prevent the burn pile from starting a larger fire. In the version of FIG. 11B, the enclosure barrier 950 is an inward protection system 960 with the front side 150 of the fire-resisting sheet or sheets 130 facing outward. The inward protection system 960 can be used to protect a structure 965, such as a house 970 or other property, or some other object from an open fire, particularly when the open fire surrounds the structure 965 or has the possibility of surrounding the structure 965. In a particular version, the inward protection system 960 can be set up around a particularly important object, such as a very old tree or grove of trees, that it is desired to protect. In this version, the fire-resisting sheet or sheets 130 can be supported on vertical support members 160 or the fire-resisting sheet or sheets 130 can be attached directly to a tree with the tree serving as the support structure 135.

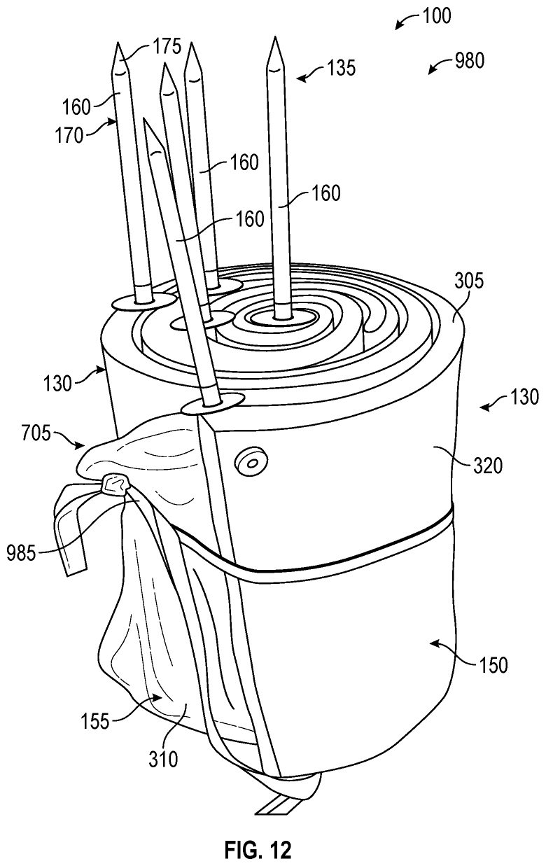

FIG. 12 illustrates the portability and ease of set of up a version of the fire barrier system 100. In this version, the fire barrier system 100 is sufficiently flexible to be able to be rolled into a rolled configuration 980. A tie 985 can be provided to maintain the fire barrier system 100 in the rolled configuration 980. In the rolled configuration 980, the fire barrier system 100 can be easily transported to a deployment site. Once there, the tie 985 can be untied, and the fire barrier system 100 can be unrolled into a fire-resisting sheet or sheets 160 that can then be supported in position by a support structure 135. In the version shown, the support structure 135 is a plurality of vertical support members 160 that are preattached to the fire-resisting sheet or sheets 130 prior to being rolled into the rolled configuration 980. In the particular version shown, the fire barrier system is 16 feet in length and has a weight of about 60 pounds. Alternatively, the vertical support members 160 can be separated transported and attached to the fire-resisting sheet or sheets 130 at the deployment site. In another version, separable support members, such as the ones shown in FIG. 5C can be used and a portion of the vertical support members 160 can be separately transported. Alternatively still, a different type of support structure 135 can be used, such as by directly attaching the fire-resisting sheet or sheets 130 to an object at the site and/or to be protected. In the version shown, multiple fire-resisting sheets 130 are provided that are pre-attached to one another by the horizontal sheet connection mechanism 705. Alternatively, the rolled configuration 980 can be one long fire-resistant sheet 130.

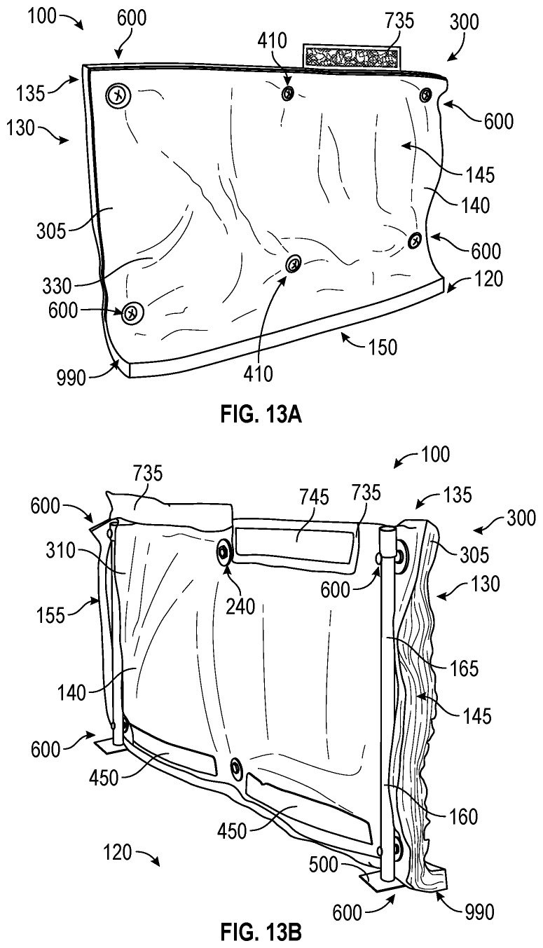

FIGS. 13A and 13B show a particular version of a fire barrier system 100 showing the front side 150 and rear side 155 of a fire-resisting sheet 130, respectively. In this version, the fire-resisting sheet 130 is connectable to the vertical support members 160 in a manner where the portion 990 of the fire-resisting sheet 130 extends beyond and below the position of the ground plate 500 by a few inches, such as from about 3 to six inches. This allows the portion 990 to drag on the ground to help make sure the fire or embers do not pass under the fire-resistant sheet 130.

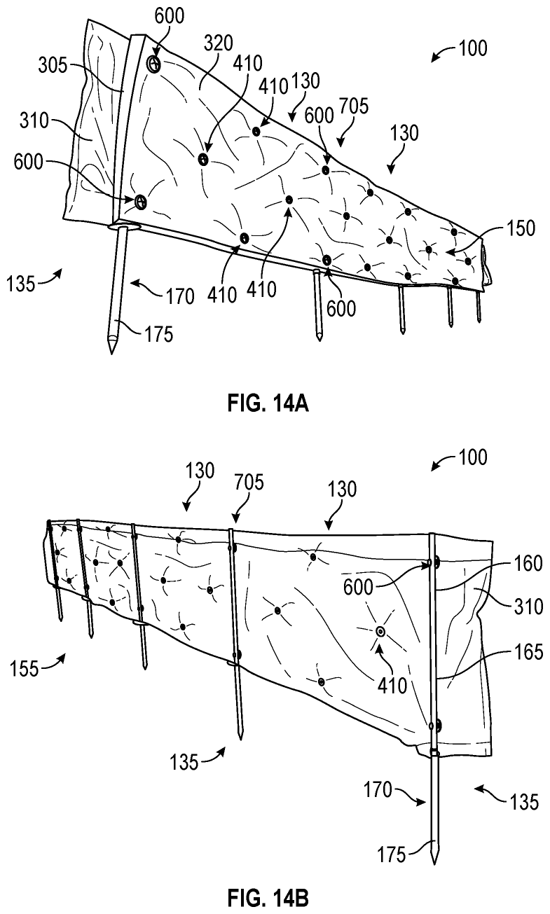

FIGS. 14A and 14B show a version of the fire barrier system 100 with multiple fire-resisting sheets 130, such as three or more, connected by a horizontal sheet connecting mechanism 705. Optionally, one version of a fire barrier system 100 having a fire-resisting sheet 130 has a fronting layer 320 that includes an additional layer of fire-resisting material, such as a Kevlar-Nomex layer.

Although the present invention has been described in considerable detail with regard to certain preferred versions thereof, other versions are possible, and alterations, permutations and equivalents of the version shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” and their variations such as “consists” should be understood to imply the inclusion of a stated element, limitation, or step and not the exclusion of any other elements, limitations, or steps or any other non-essential elements, limitations, or steps, respectively. Throughout the specification, any discussed on a combination of elements, limitations, or steps should be understood to include a disclosure of additional elements, limitations, or steps and the disclosure of the exclusion of additional elements, limitations, or steps. All numerical values, unless otherwise made clear in the disclosure or prosecution, include either the exact value or approximations in the vicinity of the stated numerical values, such as for example about +/− ten percent or as would be recognized by a person or ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and including zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A fire barrier system comprises:
a fire-resisting sheet comprising a fire-resisting layer and a support layer, wherein the fire-resisting layer comprises mineral wool, and
a support structure adapted to support the fire-resisting sheet above the ground,
wherein the fire barrier system can be positioned in proximity to a fire to help prevent the spread of the fire across the fire barrier system.

2. A system according to claim 1 wherein the support structure is adapted to support the fire-resisting sheet at least 18 inches above the ground.

3. A system according to claim 1 wherein the support structure comprises one or more vertical support members each comprising a connecting portion and an anchoring portion.

4. A system according to claim 3 wherein the anchoring portion comprises a stake adapted to be inserted into the ground.

5. A system according to claim 1 wherein the fire-resisting layer further comprises a wetting agent.

6. A system according to claim 1 wherein the support layer comprises a para-aramid or a meta-aramid.

7. A system according to claim 6 wherein the support layer comprises both a para-aramid and a meta-aramid.

8. A system according to claim 1 wherein the fire-resisting sheet comprises a third layer, the third layer comprising a fabric.

9. A system according to claim 8 wherein the fabric comprises polyethylene terephthalate.

10. A system according to claim 1 wherein the fire-resisting sheet comprises a wire layer.

11. A system according to claim 1 wherein the fire resisting sheet comprises a sheet connecting mechanism adapted to connect the fire-resisting sheet to a second fire-resisting sheet, the sheet connecting mechanism comprising an extending portion of the fire-resisting sheet that extends beyond the fire-resisting layer, the extending portion comprising a fastening member adapted to connect to the second fire-resisting sheet in a manner that maintains fire barrier properties of the system.

12. A fire barrier system comprises:
a first fire-resisting sheet comprising a fire-resisting material,
a second fire-resisting sheet comprising a fire-resisting material, and
a sheet connection mechanism adapted to connect the first fire-resisting sheet to the second fire-resisting sheet to extend the length or height of the fire barrier system.

13. A fire-barrier system according to claim 12 wherein the sheet connection mechanism comprises an extending portion of the first sheet that extends beyond the fire-resisting material of the first sheet, wherein the extending portion contains a first fastening member, wherein the second fire-resisting sheet comprises a second fastening member, and wherein the first fastening member can engage a second fastening member to connect the first fire-resisting sheet to the second fire-resisting sheet in a manner that maintains fire barrier properties of the system.

14. A fire barrier system according to claim 12 wherein the sheet connecting mechanism comprises a horizontal connecting mechanism and a vertical connecting mechanism.

15. A fire barrier system according to claim 12 wherein the fire-resisting material passes the ASTM vertical flame test.

16. A fire barrier system according to claim 12 wherein the fire-resisting material comprises mineral wool.

17. A fire barrier system according to claim 12 wherein the first fire resisting sheet further comprises a para-aramid or a meta-aramid.

18. A method of creating a fire barrier between a fire and an area to be protected from the fire, the method comprising:
supporting a fire-resisting sheet above the ground at a location between the fire and the area to be protected from the fire, the fire resisting sheet comprising a fire-resisting material.

19. A method according to claim 18 wherein the fire-resisting sheet is supported at a location in proximity to a fire break line.

20. A method according to claim 18 further comprising connecting the fire-resisting sheet to another fire-resisting sheet to extend the length or height of the fire barrier.
